(19) United States
(12) Patent Application Publication
(10) Pub. No.: US 2005/0258757 A1
(43) Pub. Date: Nov. 24, 2005

(54) Metal halide lamp

(75) Inventor: Jorgen Meeusen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N. V., Groenewoudseweg (NL)

(21) Appl. No.: 10/520,874

(22) PCT Filed: Jun. 17, 2003
(86) PCT No.: PCT/IB03/02745

§ 371 Date: Jan. 11, 2005

(30) Foreign Application Priority Data
Jul. 17, 2002 (EP) 02077883.3

(51) Int. Cl. H01J 17/16; H01J 61/30

(52) U.S. Cl. 313/634

(57) ABSTRACT

A metal halide lamp comprising a substantially cylindrical discharge vessel (3) having an internal diameter Di and filled with an ionizable filling, wherein two electrodes (4, 5) are present at a mutual distance EA for maintaining a discharge in the discharge vessel (3), wherein EA/Di>4, and wherein the ionizable filling contains PrI3.

The invention relates to a metal halide lamp comprising a substantially cylindrical discharge vessel having an internal diameter Di and filled with an ionizable filling, wherein two electrodes are present at a mutual distance EA for maintaining a discharge in the discharge vessel, and wherein EA/Di>4.

Such a lamp is described in the international patent publication WO 98/25294, and may be used for street lighting purposes for instance. In said publication a filling is proposed which, besides NaI, contains CeI₃. This lamp is based on the recognition that a high efficacy and a good color rendering is possible when sodium halide is used as a filling ingredient of a lamp and a strong widening and inversion of the Na emission in the Na-D lines takes place during lamp operation. This requires a high coldest-spot temperature in the discharge vessel, which excludes under practical conditions the use of quartz or quartz glass for the discharge vessel wall and renders the use of a ceramic material for the discharge vessel wall preferable. The term “ceramic wall” in the present description and claims is understood to cover a wall of metal oxide such as, for example, sapphire or densely sintered polycrystalline Al₂O₃, as well as metal nitride, for example AlN. The known lamp combines a good color rendering with a comparatively wide range of the color temperature.

One drawback of the known lamp is that due to the relatively elongated shape of the discharge vessel in combination with a relatively high total pressure (start gas and buffer gas) all species in the discharge vessel are segregated along the burner axis if the lamp is operated in a vertical burning position, resulting in species having a high density moving to the bottom and species having a low density moving to the top. The result of this segregation is a large visible shift in correlated color temperature (CCT). This problem occurs in particular if the discharge vessel does not only have a relatively elongated shape (Ea/Di>4), but also a narrow internal diameter Di, for instance less than 5 mm (for a 70 W lamp), because in such a small vessel turbulent mixing of the filling hardly takes place. The object of the invention is a metal halide lamp with an elongated discharge vessel wherein said color shift is minimized, while maintaining the same level of efficacy as in the known lamp.

In order to achieve that goal, the ionizable filling according to the invention contains PrI₃. It was found that if this salt is applied as a replacement filling ingredient for CeI₃ in a lamp of the mentioned type, said color shift is limited compared to a conventional filling containing CeI₃.

Preferably the filling further contains NaI, wherein the molar ratio NaI/PrI₃ lies between 3 and 30, preferably between 4 and 20, more preferably between 5 and 12. The discharge vessel preferably contains between 0.15 and 1.5 mg/cm3 PrI₃, more preferably between 0.2 and 1.0, still more preferably between 0.25 and 0.6 mg/cm³. Thereby a lamp with an efficacy of more than 110 Lumen/Watt, having a color temperature (CCT) of for instance 2800 K can be obtained, wherein the color shift between horizontal and vertical operation can be limited to less than 360 K.

The filling further preferably comprises Hg, wherein the Hg-pressure during lamp operation in the discharge vessel lies between 5 and 40 bar, preferably between 10 and 25 bar, and more preferably is approximately 15 bar. Alternatively Zn or Xe can be applied instead, as long as the total pressure of these gasses is within said range. In practice the wall load value of the discharge vessel between the electrodes is preferably more than 10 W/cm², more preferably more than 20 W/cm², still more preferably more than 30 W/cm².

These and further aspects of the lamp according to the invention will be explained in more detail with reference to the drawings (not to scale), wherein:

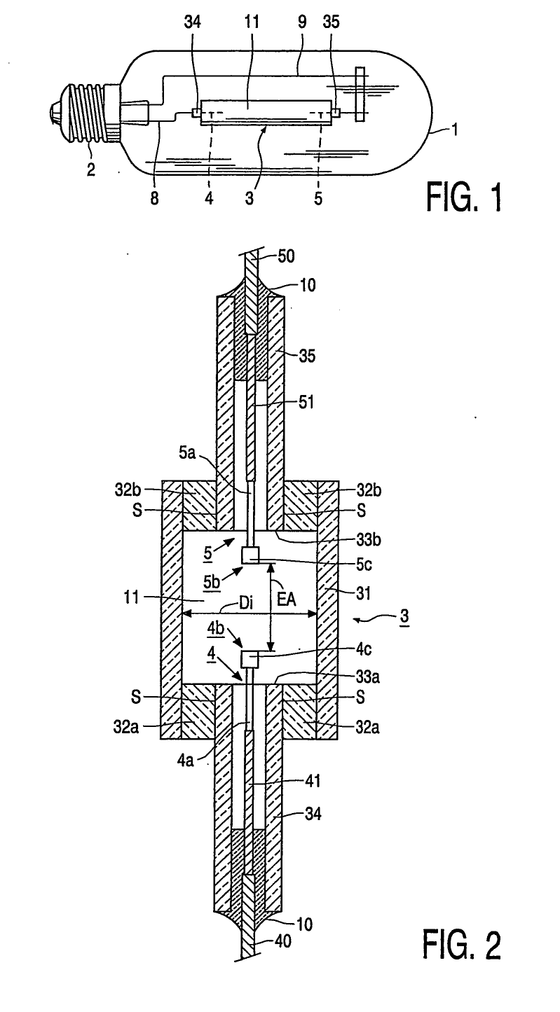

FIG. 1 diagrammatically shows a lamp according to the invention; and

FIG. 2 shows the discharge vessel of the lamp of FIG. 1 in detail.

FIG. 1 shows a metal halide lamp provided with a discharge vessel 3 having a ceramic wall, which encloses a discharge space 11 containing an ionizable filling. Two electrodes 4, 5 whose tips 4b, 5b are at a mutual distance EA are arranged in the discharge space, and the discharge vessel has an internal diameter Di at least over the distance EA. The discharge vessel is closed at one side by means of a ceramic projecting plug 34, 35 which encloses a current lead-through conductor (FIG. 2: 40, 41, 50, 51) to an electrode 4, 5 positioned in the discharge vessel with a narrow intervening space and is connected to this conductor in a gastight manner by means of a melting-ceramic joint (FIG. 2: 10) at an end remote from the discharge space. The discharge vessel is surrounded by an outer bulb 1 which is provided with a lamp cap 2 at one end. A discharge will extend between the electrodes 4, 5 when the lamp is operating. The electrode 4 is connected to a first electrical contact forming part of the lamp cap 2 via a current conductor 8. The electrode 5 is connected to a second electrical contact forming part of the lamp cap 2 via a current conductor 9. The discharge vessel, shown in more detail in FIG. 2 (not to scale), has a ceramic wall and is formed from a cylindrical part with an internal diameter Di which is bounded at either end by a respective end wall portion 32a, 32b, each end wall portion 32a, 32b forming an end surface 33a, 33b of the discharge space. The end wall portions each have an opening in which a ceramic projecting plug 34, 35 is fastened in a gastight manner in the end wall portion 32a, 32b by means of a sintered joint S. The ceramic projecting plugs 34, 35 each narrowly enclose a current lead-through conductor 40, 41, 50, 51 of a relevant electrode 4, 5 having a tip 4b, 5b. The current lead-through conductor is connected to the ceramic projecting plug 34, 35 in a gastight manner by means of a melting-ceramic joint 10 at the side remote from the discharge space.

The electrode tips 4b, 5b are arranged at a mutual distance EA. The current lead-through conductors each comprise a halide-resistant portion 41, 51, for example in the form of a Mo—Al₂O₃ cermet and a portion 40, 50 which is fastened to a respective end plug 34, 35 in a gastight manner by means of the melting-ceramic joint 10. The melting-ceramic joint extends over some distance, for example approximately 1 mm, over the Mo cermet 40, 41. It is possible for the parts 41, 51 to be formed in an alternative manner instead of from a Mo—Al₂O₃ cermet. Other possible constructions are known, for example, from EP 0 587 238. A particularly suitable construction was found to be a halide-resistant coil applied around a pin of the same material. Mo is very suitable for use as a highly halide-resistant material. The parts 40, 50 are made from a metal whose coefficient of expansion corresponds very well to that of the end plugs. Nb, for example, is a highly suitable material for this purpose. The parts 40, 50 are connected to the current conductors 8, 9 in a manner not shown in any detail. The lead-through construction described renders it possible to operate the lamp in any desired burning position.

Each of the electrodes 4, 5 comprises an electrode rod 4a, 5a which is provided with a coil 4c, 5c near the tip 4b, 5b. The projecting ceramic plugs are fastened in the end wall portions 32a and 32b in a gastight manner by means of a sintered joint S. The electrode tips then lie between the end surfaces 33a, 33b formed by the end wall portions. In an alternative embodiment of a lamp according to the invention, the projecting ceramic plugs 34, 35 are recessed behind the end wall portions 32a, 32b. In that case the electrode tips lie substantially in the end surfaces 33a, 33b defined by the end wall portions.

In a practical embodiment of the lamp according to the invention as shown in the drawing, the rated lamp power is 70 W. The lamp has a lamp voltage of 150 V and is an optical retrofit for operating in a high pressure sodium fixture. The electrode interspace EA is 17 mm, the internal diameter Di 4 mm, so that the ratio Ea/Di=4.25. The wall thickness of the discharge vessel is 0.8 mm. The lamp accordingly has a wall load between the electrodes of 32.8 W/cm².

The ionizable filling of the discharge vessel comprises Ar or Xe (for example with a filling pressure at room temperature of 300 mbar) as an ignition gas. Furthermore, the filling comprises Hg with a filing pressure during operation of 15 bar.

Alternatively Zn or Xe can be used instead of Hg as long as the total pressure (the pressure of start gas and buffer gas) is the same as in the situation where Hg is used. The ionizable filling of the lamp comprises 4.05 mg NaI and 0.84 mg PrI₃, resulting in a high-efficacy lamp having excellent color properties, which shows a relatively small color shift when moved from a horizontal to a vertical operational position. If a lamp is required which transmits white light, more PrI₃ and less NaI should be used.

1. A metal halide lamp comprising a substantially cylindrical discharge vessel (3) having an internal diameter Di and filled with an ionizable filling, wherein two electrodes (4, 5) are present at a mutual distance EA for maintaining a discharge in the discharge vessel (3), and wherein EA/Di>4, characterized in that the ionizable filling contains PrI₃.

2. A lamp according to claim 1, wherein the filling further contains NaI, and wherein the molar ratio NaI/PrI₃ lies between 3 and 30, preferably between 4 and 20, more preferably between 5 and 12.

3. A lamp according to claim 1, wherein the discharge vessel (3) contains between 0.15 and 1.5 mg/cm³ PrI₃, preferably between 0.2 and 1.0, more preferably between 0.25 and 0.6 mg/cm³.

4. A lamp according to claim 1, wherein the filling further comprises Hg, and wherein the Hg-pressure during operation in the discharge vessel (3) lies between 5 and 40 bar, preferably between 10 and 25 bar, and more preferably is approximately 15 bar.

5. A lamp according to claim 1, wherein the wall load value of the discharge vessel (3) between the electrodes (4, 5) in practice is more than 10 W/cm², preferably more than 20 W/cm², more preferably more than 30 W/cm².

6. A lamp according to claim 1, wherein the discharge vessel (3) has a ceramic wall.

7. A lamp according to claim 1, wherein the internal diameter Di is less than 5 mm.
